(19) United States
(12) Patent Application Publication
(10) Pub. No.: US 2009/0177844 A1
(43) Pub. Date: Jul. 9, 2009

(54) METHOD OF EFFICIENTLY CHOOSING A CACHE ENTRY FOR CASTOUT

(75) Inventors: Bruce Eric Naylor, Morgan Hill, CA (US); David Edwin Ormsby, San Jose, CA (US); Betty Joan Patterson, Hollister, CA (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/970,743

(22) Filed: Jan. 8, 2008

(51) Int. Cl. G06F 12/12

(52) U.S. Cl. 711/136; 711/E12.069

(57) ABSTRACT

The present invention relates generally to a method and system for efficiently identifying a cache entry for cast out in relation to scanning a predetermined sampling subset of pseudo-randomly sampled cached entries and determining a least recently used (LRU) entry from the scanned cached entries subset, thereby avoiding a comprehensive review of all of or groups of the cached entries in the cache at any instant. In one or more implementations, a subset of the data entries in a cache are randomly sampled, assessed by timestamp in a doubly-linked listing and a least recently used data entry to cast out is identified.

### FIELD OF THE INVENTION

The present invention relates generally to the field of microprocessors, and more particularly but not exclusively to caching within and in relation to microprocessors and activities of microprocessors.

### BACKGROUND OF THE INVENTION

Reliance on software-based data systems is increasing every year both as data becomes more important and as languages provide more options for obtaining additional value from the data and systems. Timely access to data in the data systems therefore is of critical importance. Caching is a widely understood method of providing a short-term storage location for quick data access in data systems.

FIG. 1 depicts a typical data system 100 comprising a computer user interface 102 in communication with a central processing unit (CPU) (i.e., microprocessor) at 103. Also at 103, the CPU is typically connected or in communication with internal memory, cache memory 110, and a capability to interface with a user through an application, program code or other software, including an operating system. Data is accessible by the user through the interface, commands being instructed within the system in response to the CPU, to obtain data from the cache 110 or a data storage device at 104. Alternatively data may be accessed through a data management system directly or indirectly, often through a data engine, at 105. The data management system is typically for managing data in the data system in a manner such as on a transactional basis, but not limited to such. Other data storage centers, devices and databases are also typically accessible through a data management system, such as at 106. Further, a user or data management system may access or have instructions from applications apart from the data system, such as those at 108. As used herein the term data system includes data processing systems and their associated hardware and software, typically having files organized in one or more databases in communication with hardware and software available for a user via a user interface available through an operating system.

A cache is typically used to speed up certain computer operations by temporarily placing data, links, or a temporary copy of predetermined data, in a specific location where it may be readily accessed more rapidly than in a normal storage location such as a hard disk for instance. A cache is also understood to be a block of memory for temporary storage of data likely to be used again. For example, specific data in a data system that is stored on a storage disk operational with the data system, may be cached temporarily in high-speed memory so that it may be identified and accessed (i.e., read and written) more quickly than if the same data were to need to be obtained directly from the storage disk itself. In another example, a processing device (i.e., microprocessor) may use an on-board memory cache or localized memory cache to store temporary data specific for use during certain processing operations. While different cache clients of a data system routinely access and use cache, such as but not limited to microprocessors, central processing unit (CPU), operating systems, and hard drives, other technologies also access cache functions such as web-based technologies including web browsers and web servers for instance. These types of accessing, using and processing elements, which are coupled or in communication with a cache memory, are collectively referred to herein as cache client(s).

FIG. 2 depicts an example of a pictorial relation 200 as between a main memory in a data system 210 and a cache memory 220. In the example of FIG. 2, the main memory 210 has data that can be categorized by index and data characterizations or content at 211. Data entries in the main memory having an index of 0, 1, 2 and 3 are set forth as 212, 213, 214 and 215, respectively. Typically, a cache 220 is comprised of a pool of data entries and each data entry 224, 226, and 228 has a data portion (i.e., data or datum that is a copy), a data tag (which specifies the identity of the datum), an index and sometimes a timestamp of creation or access, at 222. In FIG. 2, data entry 224 in the cache is related to data entry 215 of the main memory as shown by 230. Similar relationships for other data entries are shown at 240 and 250. However, for main memory data entry 214, there is no equivalent or relational data entry in the cache 220. As used herein the terms data and datum are intended to be used interchangeably and reflect the type of information resident or situated in a respective element, device or system.

Operationally, cache memory is readily and quickly accessible by the microprocessor of a data system (i.e., computer, computer system, and similar devices controlled by one or more microprocessors) based upon instructions from operations of the system. When a cache client seeks to locate or access data stored in the data system, the cache client communicates with the cache to determine if the data sought is available in the cache and whether there is an associated data tag. If the sought data and its proper data tag are identified in the cache, a “cache hit” has occurred and the datum (or data) in the cache is used. If the sought data and its proper data tag are not identified in the cache, a “cache miss” has occurred and the other non-cache storage locations are searched for the specific data and data tag. Once the sought data is found after a cache miss, the found data is usually inserted in the cache and is then available for a subsequent request more timely from the cache.

For example, in a cache hit, a web browser program following a first check of its local cache on a local computer identifies a local copy of the contents of the sought web page (i.e., data or datum) of the data tag which is a particular uniform resource locator (URL). Once identified, the browser could load the web page for display to the user more quickly than newly accessing, downloading and displaying the contents from the actual URL.

Contradistinctively, a cache miss occurs in the example where a web browser program following a first check of its local cache on a local computer fails to identify a local copy of the contents of the sought web page of a the data tag which is a particular uniform resource locator (URL) as the copy is not available in the cache. Once the data is identified and obtained elsewhere, whether in the system or externally, the browser could thereafter load the web page to be displayed to the user and also provide the cache with the data and an associated data tag. Thereafter, if there is a subsequent request of the web page, a cache hit may occur and the display to the user could occur more quickly than newly accessing, downloading and displaying the contents from the actual URL. From FIG. 2, a search of main memory data entry 214 would yield a cache miss result.

Unfortunately, a cache has limited storage resources and as more data is populated in the cache, at a predetermined point, the cache will become full. Once a cache is full, no new entries may be added unless first certain previously cached data is be removed (i.e., an entry is ejected or “cast out”) from the cache. The heuristic used to select the entry to eject or cast out is known as the replacement policy. As used herein the terms “entry,” “data buffer,” and “buffer” are intended to be used interchangeably unless otherwise expressly excepted.

Various traditional replacement policies have been attempted. For instance one common replacement policy is to replace the least recently used (LRU) buffer. While this basic LRU policy provides for replacement of data within constrained resource limits, it essentially requires that every buffer in the cache first be scanned to determine which is used least before casting out the least used entry. Further, even this basic policy has proven expensive and time-consuming to simply add new data to the cache.

An alternative replacement policy, based on similar least used characteristics, requires a user to maintain a data structure such as a binary tree defining the entries so that search time may be reduced. However, even with this policy approach, the data structure must be constantly rebalanced and tuned each time data is to be retrieved.

A further alternative replacement policy may be include complex algorithmic approaches which measure, compute and compare various characteristics of each buffer such as use frequency versus stored content size, latencies and throughputs for both the cache and the origin, and the like. Though the additional complexity may improve the choice of the selected entry to be replaced, the efficiency, expense and time involved in its operation is often prohibitive.

These approaches using standard LRU queues often perform linearly and may also create contention on the latching/locking for the LRU queues.

Therefore, it is highly desired to be able to provide an optimal solution which overcomes the shortcomings and limitations of the present art and more particularly provides a method and system for efficiently selecting a cache entry for cast out without first requiring a comparative and complete review of all of the cached entries or otherwise maintaining data structures recognizing a complete grouping of cached entries, and yet provides timely and improved replacements, efficiencies and access to data.

The present invention, in accordance with its various implementations herein, addresses such needs.

### SUMMARY OF THE INVENTION

In various implementations of the present invention, a method and system are provided for efficiently identifying a cache entry for cast out in relation to scanning a predetermined sampling subset of pseudo-randomly sampled cached entries and determining a least recently used (LRU) entry from the scanned cached entries subset, thereby avoiding a comprehensive review of all of or groups of the cached entries in the cache at any instant.

In one or more implementations, the present invention is a method for identifying a data entry of a cache for cast out, comprising steps of: defining a sample of data entries of the cache as a linked-list chain of data entries, evaluating one or more data entries in the linked-list chain in relation to one or more predetermined characteristics, and identifying a least recently used data entry for cast out.

In other implementations, a subset of the data entries in a cache are randomly sampled, assessed by timestamp in a doubly-linked listing and a least recently used data entry cast out is identified.

In other implementations, a data system having an instantiable computer program product for identifying a data entry of a cache coupled with one or more cache clients for cast out from one or more data entries in a cache containing from a data storage device of a data system having a centralized processing unit (CPU) is provided.

### BRIEF DESCRIPTION OF THE DRAWINGS

FIG. 1 depicts a typical data system 100 comprising a computer user interface in communication with a central processing unit (CPU) (i.e., microprocessor);

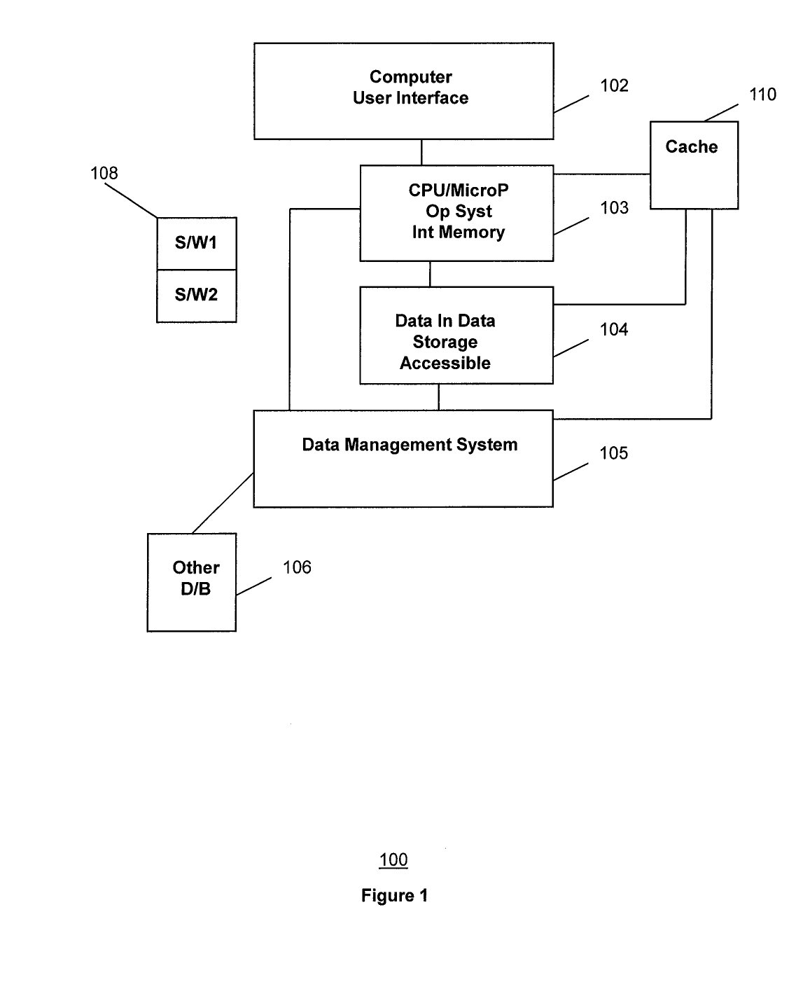

FIG. 2 depicts an example of a pictorial relation as between a main memory in a data system and a cache memory;

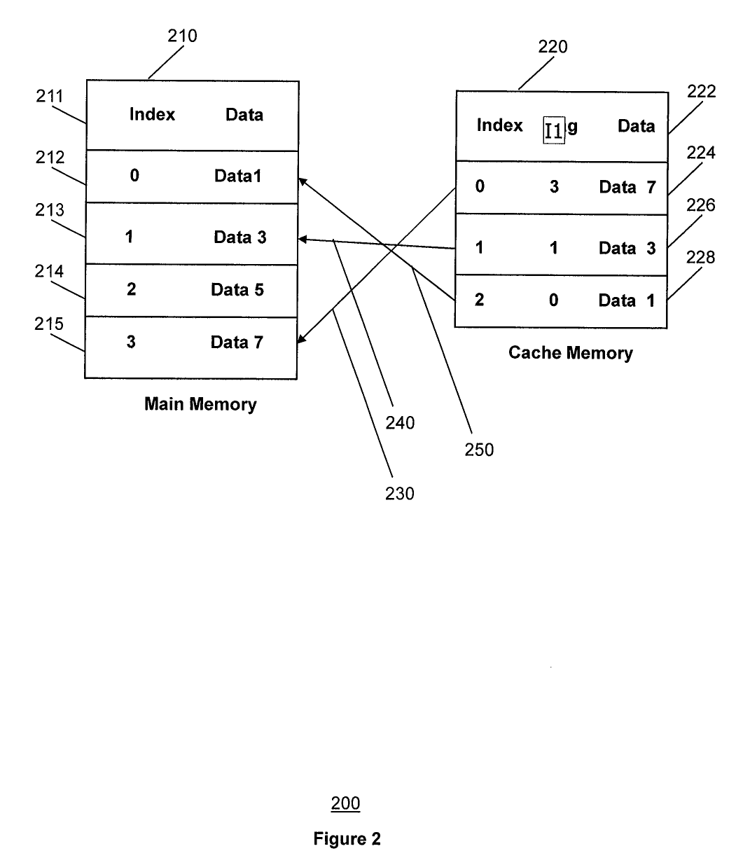

FIG. 3 depicts a flow diagram of a process for scanning a random subset of cache entries, identifying the least recently used data entry from the scanned subset, and casting out the identified data entry, in accordance with one or more implementations;

FIG. 4 depicts a flow diagram of a process for scanning a random subset of cache entries, identifying the least recently used data entry from the scanned subset, and casting out the identified data entry, where data entries are identified as being inconsistent with one another, in accordance with one or more implementations; and,

FIG. 5 depicts a diagram of a doubly-linked list having nine data entries as determined by the process, where a sample size of three will be used, in accordance with one or more implementations herein.

### DETAILED DESCRIPTION

The present invention relates generally to a method and system for efficiently identifying a cache entry for cast out in relation to scanning a predetermined sampling subset of pseudo-randomly sampled cached entries and determining a least recently used (LRU) entry from the scanned cached entries subset, thereby avoiding a comprehensive review of all of or groups of the cached entries in the cache at any instant.

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

As used herein, as will be appreciated, the invention and its agents, in one or more implementations, separately or jointly, may comprise any of software, firmware, program code, program products, custom coding, machine instructions, scripts, configuration, and applications with existing software, applications and data systems, and the like, without limitation.

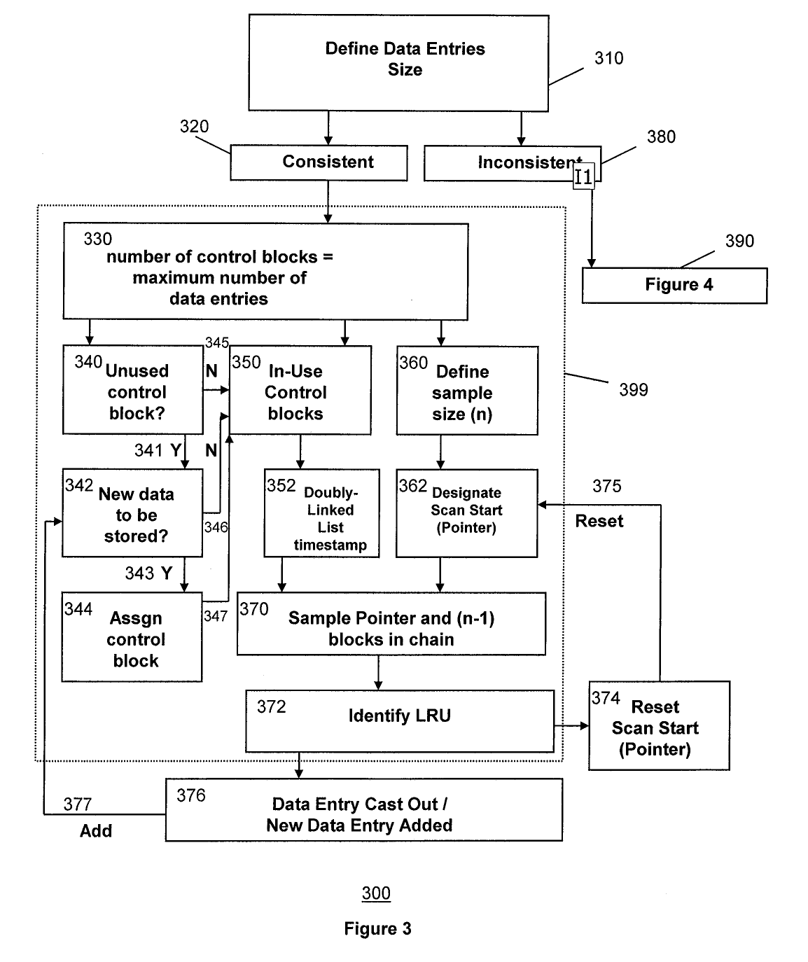

FIG. 3 depicts a flow diagram 300 of a process for scanning a random subset of cache entries, identifying the least recently used data entry from the scanned subset, and casting out the identified data entry, in accordance with one or more implementations. Advantageously, the process sets forth a method wherein the subset size is sufficiently random statistically and the likelihood of rescanning a recently scanned data entry in a subsequent scan is substantially reduced.

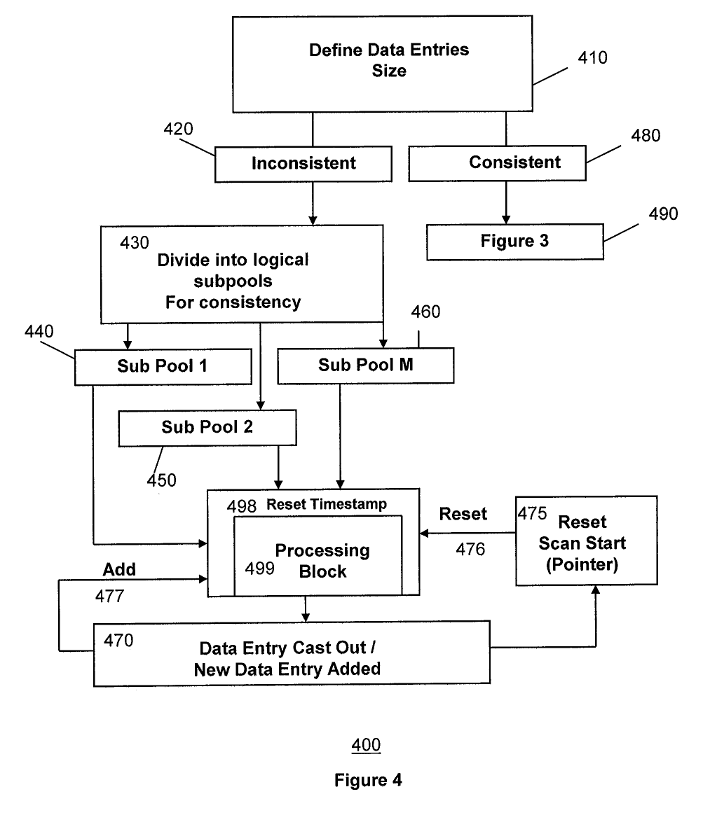

From FIG. 3, initially, an assessment is performed to determine whether all of the data entries in the cache are the same size by comparing the data entry sizes at 310. Additionally, at 310, a resource maximum is identified in relation to the cache, or a resource limit is set at a predetermined value in relation to the cache at issue, as the cache is expected to contain only a fixed maximum number of entries (i.e., resource allocation). Alternatively, at 310, all data entries in a cache are deemed to be similar in size. Following the assessment, the data entry sizes in a specific cache are determined as being consistent at 320 or inconsistent at 380. In the event the data entries in a cache are determined to be inconsistent, the process 300 first undergoes the steps set forth in the process of FIG. 4 (described supra) at 390.

In the event the data entries in a cache are determined to be consistent at 320, the number of preallocated control blocks is determined at 330 as each preallocated control block exists in relation to tracking data entries for the cache. Once the number of preallocated blocks is determined, the number of data entries is determined as equal to the number of preallocated control blocks. It is assumed that the number of preallocated control blocks does not exceed the resource limit of the cache.

At 340, the expected number of data entries is compared with the actual number of data entries by determining if there is unused space in the cache.

In the event there is unused space in the cache at 341, there exists one or more available control blocks for new data entries which are intended to be added at 342. If there also exists new data to be entered at 342, after the new data entry is readied to be added to the cache at 343, the new data entry is assigned an available control block at and added to the cache, at 344. Additionally, after the process has determined a cast out of a data entry and identified a new data entry to be added at 376, the new data entry undertakes similar steps at 377 to be added to the cache.

In the event there is no unused space in the cache at 345, there is no additional resources available to add a new data entry until a cast out of an existing data entry can be performed. Similarly, even where there may exist available unused control blocks at 342, if there is no new data entry to add at 342 then no new data entry will be added at 346.

From FIG. 3, at 350, all in-use control blocks are chained together in a doubly-linked list. It will be understood by those skilled in the art that a linked list is a fundamental data structure which is often used to implement other data structures. A linked list consists of a sequence of nodes, each containing arbitrary data fields and one or two references (“links”) pointing to the next and/or previous nodes. Preferentially, a linked list is often of an order where the linked items may be different from the order that the data items are stored in memory, cache or on a disk, thereby allowing the list of data entries to be traversed in a different order. As used herein a linked list is a self-referential datatype containing a pointer or link to another datum of the same type. A doubly-linked list is a more complex linked list type as it is a two-way linked list. As used herein, in a doubly-linked list, each node has two links: one points to the previous node, or points to a null value or empty list if it is the first node; and one points to the next, or points to a null value or empty list if it is the final node. A doubly-linked list also contains three integer values: the value, the link forward to the next node, and the link backward to the previous node. Preferentially, in one or more implementations herein, the value is associated with a timestamp of the data entry which is held by the control block indicating when the data entry was last used.

From FIG. 3, at 360, the sample size of interest is defined or a predetermined value is used as defining “n”. At 362 the scan starting point is determined. The scan starting point includes the data entry block which is part of the overall sample to be assessed. The sample at 370 consists of the scan starting block from 362 and the next (n−1) blocks in the chain from the doubly-linked list of 352.

From FIG. 3, at 370, the sample or subset of the data entries of the cache has been determined. Accordingly, an assessment of the timestamps located in the control blocks of each of the data entries in the sample at 370 is performed at 370 and a least recently used data entry is determined and identified from the sample in relation to the timestamps at 372. The identified least recently used data entry is then cast out at 376.

Once the least recently used data entry is identified, the scan starting point is set to the control block subsequent to (i.e., following) the last control block scanned in the sample. As a result, the next scan will generally contain a completely different sampling of the cache data entries in various implementations.

From FIG. 3, block 399 represents the processing of one or more implementations herein, inclusive of the description above and in relation to that depicted in FIG. 3, to determine a data entry to cast out.

Advantageously, the various implementations provide for the situation where the designated scan starting point (i.e., pointer) may not be an “in use” control block and the process will still proceed. For instance, in such a situation, though the designating scan starting point is not an “in use” control block, such a block (i.e. a “not in use” block) can only exist where data entries are available in the cache (i.e., when the cache is not full). Accordingly, when the cache is not full, there is no need to cast out data entries from the cache.

FIG. 4 depicts a flow diagram 400 of a process for scanning a random subset of cache entries, identifying the least recently used data entry from the scanned subset, and casting out the identified data entry, where data entries are identified as being inconsistent 420 with one another, in accordance with one or more implementations. FIG. 4 depicts a process flow in relation to 390 of FIG. 3.

From FIG. 4, for a cache containing different data entry sizes where there is inconsistency in the sizing, the cache is divided into logical subpools at 430, each of which contains only one size of data at 440, 450 and 460. Operationally, in one or more implementations, the process then treats each subpool as a separate cache to be processed. The processing of each subpool is performed by the processing block 499 which is intended to comprise the steps set forth in block 399 of FIG. 3 with the additional step of resetting the timestamp in the control block at 498. Operationally, when a data entry to cast out needs to be identified using the processing 499, the process operates in constant time in relation to cache size. Though subpools 1, 2 and M are depicted in FIG. 3 as 440, 450 and 460 respectively, it is envisioned that the number of subpools for a particular cache is determined in relation to the number of different data sizes in the initiating cache.

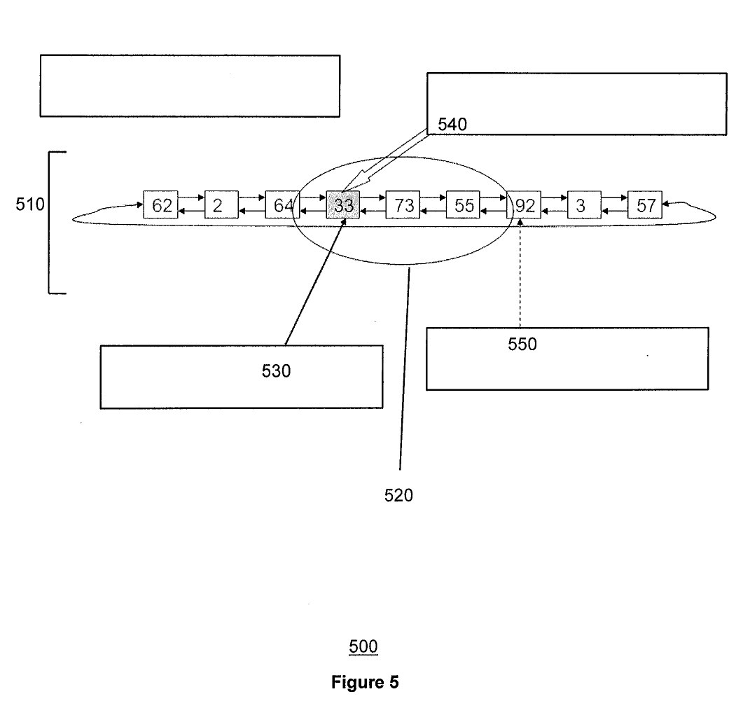

FIG. 5 depicts a diagram 500 of a doubly-linked list 510 having nine data entries as determined by the process, where a sample size of three will be used, in accordance with one or more implementations herein. From FIG. 5, the start scan point (i.e., pointer) is set for the data entry having a timestamp of 33. Since the sample size was determined as 3 (i.e., “n”), the chain for scanning includes the next (n−1) or 2 data entries which are timestamped as 73 and 55 at 520. Using the process in one or more implementations, such as that of 399 in FIG. 3, it is determined that the data entry with the timestamp of 33 is identified for cast out as it is the least recently used data entry of the sample (i.e., it has the lowest timestamp value of the sample).

The present invention in one or more implementations may be implemented as part of a data system, an application operable with a data system, a remote software application for use with a data storage system or device, and in other arrangements.

Advantageously, for example, it will be recognized by those skilled in the art that the quality of the results of the present invention are in relation to the absolute number of entries sampled, and not in relation to the size of the cache or the percentage of all entries sampled. By example, if the sample size is 100 entires, the probability that the selected entry for cast out as being among approximately the least recently used 5% of all of the entries is greater than or equal to 99.4%, independent of the size of the cache, assuming a truly random sample.

It will be appreciated by those skilled in the art that the term “least recently used” in the context of the present invention and its various implementations is not intended to be exactly or absolutely descriptive of any selected cache entry for cast out in relation to a comprehensive listing of entries in the cache memory at a particular instant of time. Rather the term is intended to be generally descriptive that the selected entry for cast out is approximately a least recently used entry in the context of the entire cache memory and is the least recently used entry within the sample, particularly in relation to a selection based on a pseudo-random selection process.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

Various implementations of a data retrieving method and system have been described. Nevertheless, one of ordinary skill in the art will readily recognize that various modifications may be made to the implementations, and any variations would be within the spirit and scope of the present invention. For example, the above-described process flow is described with reference to a particular ordering of process actions. However, the ordering of many of the described process actions may be changed without affecting the scope or operation of the invention. Accordingly, many modifications may be made by one of ordinary skill in the art without departing from the spirit and scope of the following claims.

What is claimed is:

1. A method for identifying a data entry of a cache for cast out, comprising:
defining a sample of data entries of the cache as a linked-list chain of data entries, wherein the sample is comprised of “n” data entries and the chain is comprised of “m” data entries, where m is greater than or equal to n; wherein the sample is comprised of a designated scan starting data entry and (n−1) data entries subsequent to the starting data entry;
evaluating one or more data entries in the linked-list chain in relation to one or more predetermined characteristics;
identifying at least recently used data entry for cast out; and
identifying a new data entry for addition to the cache and adding the identified new data entry to the cache after assigning the new data entry a control block following cast out of the least recently used data entry; wherein the linked-list chain comprising in use control blocks of data entries of the cache having timestamps, and evaluating one or more data entries further comprises comparing the predetermined characteristics being timestamps of each data entry in the sample and ranking each data entry in accordance with its respective timestamp; further comprising and prior to the step of evaluating, dividing data entries of the cache into one or more logical subpools for consistency in size in relation to size of the data entries in the sample.

2. The method of claim 1 further comprising casting out the identified least recently used data entry.

3. The method of claim 2, further comprising identifying a new data entry for addition to the cache and adding the identified new data entry to the cache after assigning the new data entry a control block following cast out of the least recently used data entry.

4. The method of claim 1, wherein the sample is defined randomly or psudeo-randomly.

5. The method of claim 4, wherein the sample comprises a scan starting pointer and a predetermined number of subsequent data entries in relation to a sample size less one.

6. The method of claim 5, further comprising the step of resetting the pointer after identifying the least recently used data entry to a data entry pointer subsequent to the sample of the chain.

7. A data system having an instantiable computer program product for identifying a data entry of a cache coupled with one or more cache clients for cast out from one or more data entries in a cache containing from a data storage device of a data system having a centralized processing unit (CPU), comprising a computer-readable storage medium having computer-readable program code portions stored therein, the computer-readable program code portions including: a first executable portion having instructions being capable of:
defining a sample of data entries of the cache as a linked-list chain of data entries, wherein the linked-list chain is a doubly-link list chain comprising of in use control blocks of data entries of the cache having timestamps, and the step of evaluating one or more data entries further comprises comparing the predetermined characteristics being timestamps of each data entry in the sample and ranking each data entry in accordance with its respective timestamp, wherein the sample is comprised of “n” data entries and the chain is comprised of “m” data entries, where m is greater than or equal to n; wherein the sample is comprised of a designated scan starting data entry and (n−1) data entries subsequent to the starting data entry; wherein the cache is operably coupled with one or more cache items.
evaluating one or more data entries in the linked-list chain in relation to one or more predetermined characteristics;
identifying a least recently used data entry for cast out; and
identifying a new data entry for addition to the cache and adding the identified new data entry to the cache after assigning the new data entry a control block following cast out of the least recently used data entry.

8. The system of claim 7, further comprising casting out the identified least recently used data entry.

9. The system of claim 7, wherein the sample is random or pseudo-random.

10. A computerized method for identifying a cache data entry for cast out from one or more data entries in a cache containing from a data storage device of a data system having a centralized processing unit (CPU), memory, an operating system, and a data management system, using one or more application programs having program instructions comprising the steps of:
defining a sample of data entries of a cache in relation to a sample size;
defining the sample as a linked-list chain of data entries;
assessing one or more characteristics of the data entries in the linked-list chain; wherein the linked-list chain is a doubly-link list chain comprising in use control blocks of data entries of the cache having timestamps, and the step of assessing one or more data entries further comprises comparing the characteristics being timestamps of each data entry in the sample and ranking each data entry in accordance with its respective timestamp;
identifying a least recently used data entry for cast out;
casting out the identified least recently used data entry; and
identifying a new data entry for addition to the cache and adding the identified new data entry to the cache after assigning the new data entry a control block following cast out of the least recently used data entry.
